(19) United States
(12) Patent Application Publication
(10) Pub. No.: US 2015/0379481 A1
(43) Pub. Date: Dec. 31, 2015

(54) System and Method for Facilitating Settlement Between Disputing Parties

(71) Applicants: Robert Steven Frankel, Encino, CA (US); Philip Nelson Tilden, JR., Highland, CA (US)

(72) Inventors: Robert Steven Frankel, Encino, CA (US); Philip Nelson Tilden, JR., Highland, CA (US)

(21) Appl. No.: 14/319,064

(22) Filed: Jun. 30, 2014

(51) Int. Cl. G06Q 20/02

(52) U.S. Cl. CPC G06Q 20/02; G06Q 50/188

(57) ABSTRACT

Methods and systems are provided for use in the settlement process for providing settlement terms between opposing parties. In at least one embodiment, the system receives dispute amounts and best offer amounts from each party. In order to proceed with the settlement process, the difference between the dispute amounts from each party is compared to and must be less than a maximum allowable dispute amount difference. Further, in at least one embodiment, the system determines a suggested settlement amount, in part, using data from each party's confidential best offer. The present system and method provide a safe and non-threatening approach to the settlement process, which promotes compromise and settlement. Moreover, the present system and method provide a simplified procedure for collecting the debt once settlement occurs.

### BACKGROUND

The subject of this patent application relates generally to settlement negotiation, and more particularly to a system and method for facilitating settlement between disputing parties.

Applicant(s) hereby incorporate herein by reference any and all patents and published patent applications cited or referred to in this application.

In disputes involving money, a plaintiff or creditor often attempts recovery from a defendant or debtor through the court system or collection services, either immediately or when attempts to directly collect the debt have failed. Some attempt to resolve the dispute through arbitration and mediation services. However, courts are often shorthanded and have increasing caseloads; and arbitration and mediation services may be too costly for small claims. Further, in arbitration and mediation, the process may become bogged down with argument and emotion. In court, judges may send the plaintiff and defendant out of the courtroom to negotiate or mediate face-to-face, in hopes that the case will settle before the hearing. Face-to-face negotiation, however, generally fails. Most people are inexperienced and intimidated with the negotiation and settlement process, which requires dispassionate problem-solving discussions on how best to find middle ground. Instead of settlement, the discussion often degrades into argument, resulting in both parties becoming more deeply entrenched and less likely to settle. After failure of the negotiation, the parties will present their cases before the judge.

The plaintiff has little control over the amount of the monetary judgment, which may full, significantly discounted, or completely denied. Moreover, the resulting monetary judgment against the defendant must thereafter be collected by the plaintiff. If the defendant refuses to pay, the plaintiff may never recover or may sell the debt to a collector at a significant loss. The defendant may not have the ability to pay the full judgment in one lump sum, as is customarily required, for example, by cash or check. Additionally, the defendant may feel that the process was unfair and one-sided, and may decide not to pay out of frustration. As a result, the plaintiff may see little or no money, and the defendant's credit score will suffer as a result of the judgment. In many cases, both parties end up feeling dissatisfied with the current process.

Aspects of the present invention fulfill these needs and provide further related advantages as described in the following summary.

### SUMMARY

Aspects of the present invention teach certain benefits in construction and use which give rise to the exemplary advantages described below.

The present invention solves the problems described above by providing a method and system for facilitating a monetary settlement process through automated settlement of a dispute, where the dispute may be between an initiating party utilizing an initiating computing device and an invited party utilizing an invited computing device over the internet. In at least one embodiment, under control of one or more computing systems configured with executable instructions, the method includes the action of: receiving a first dispute amount and a first offer amount entered by the initiating party on the initiating computing device; receiving a second dispute amount and a second offer amount entered by the invited party on the invited computing device; comparing the first dispute amount to the second dispute amount to determine a dispute amount difference; determining a suggested settlement amount utilizing a data set, where the data set contains at least one of the first offer amount and the second offer amount; and causing the suggested settlement amount to be displayed to both parties on the initiating computing device and the invited computing device, when securely logged on to the present web site.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 illustrates an example network, with a server having programs encoded on computer storage devices and configured to perform the actions of the methods, and two client computers connected to the server or other computing means through the Internet, in accordance with at least one embodiment;

FIG. 2 depicts a flow diagram that may be performed by a server or other computing means, in accordance with at least one embodiment;

FIG. 3 depicts a flow diagram that may be performed by a server or other computing means in the initial vetting stages of the settlement process, where an invitation is communicated and dispute amounts are compared, in accordance with at least one embodiment;

FIG. 4 depicts a flow diagram that may be performed by a server or other computing means in payment of the settlement service fee, in accordance with at least one embodiment; and

FIG. 5 depicts a flow diagram that may be performed by a server or other computing means in order to generate a settlement amount, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

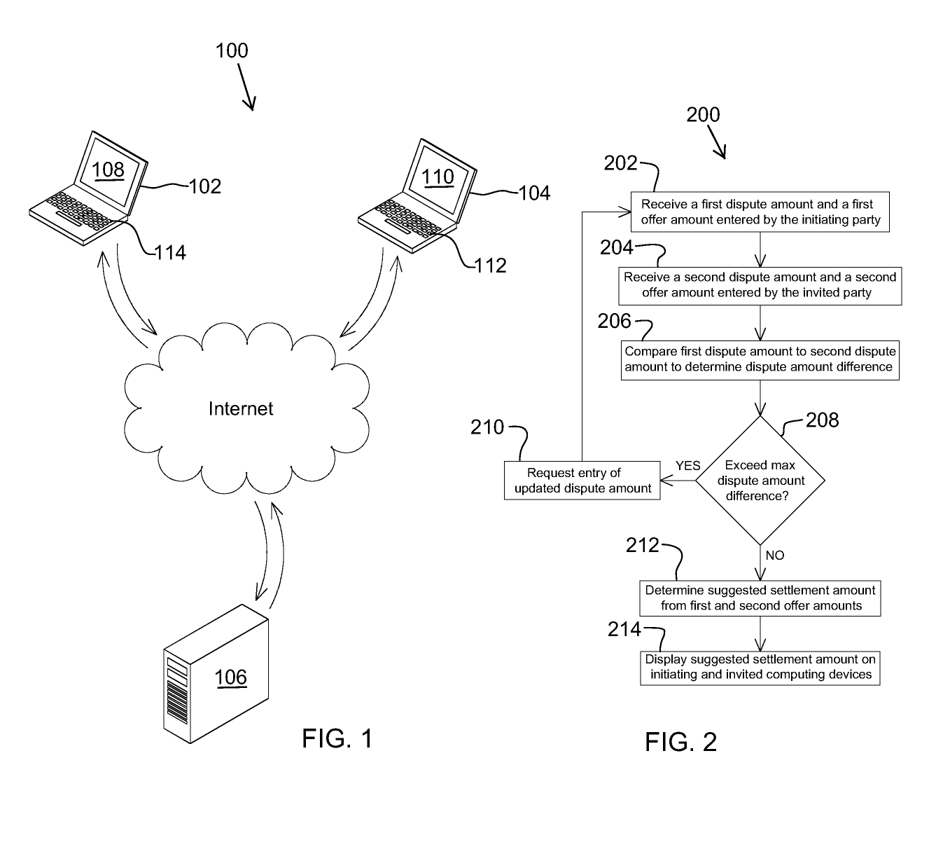

FIG. 1 illustrates an example of a computer network (100) with client computers (initiating computing device 102, and invited computing device 104) and a server (106) on which any of the methods and systems of various embodiments may be implemented. In particular the computer system, or server (106) in this example, may represent any of the computer systems and physical components necessary to perform the computerized methods discussed in connection with FIGS. 2-5 and, in particular, may represent a server (cloud, array, etc.), client, or other computer system upon which e-commerce servers, websites, web browsers and/or web analytic applications may be instantiated.

The illustrated exemplary server (106) is known to a person of ordinary skill in the art, and may include a processor, a bus for communicating information, a main memory coupled to the bus for storing information and instructions to be executed by the processor and for storing temporary variables or other intermediate information during the execution of instructions by processor, a static storage device or other non-transitory computer readable medium for storing static information and instructions for the processor, and a storage device, such as a hard disk, may also be provided and coupled to the bus for storing information and instructions. The server (106) may optionally coupled to a display for displaying information. However, in the case of servers, such a display may not be present and all administration of the server may be via remote clients. Further, the server (106) may optionally include an input device for communicating information and command selections to the processor, such as a keyboard, mouse, touchpad, and the like.

The server (106) may also include a communication interface coupled to the bus, for providing two-way, wired and/or wireless data communication to and from the server (106). For example, the communications interface may send and receive signals via a local area network or other network, including the Internet.

In the present illustrated example, the hard drive of the server (106) is encoded with executable instructions, that when executed by a processor cause the processor to perform acts as described in the methods of FIGS. 2-5. The server (106) communicates through the Internet with one or both of the initiating computing device (102) and the invited computing device (104) to cause information and/or graphics to be displayed on the screens (108, 110). An initiating party may enter information for communication to the server (106) through the keyboard (114). Likewise, an invited party may enter information for communication to the server (106) through the keyboard (112). Information transmitted to the server (106) by either the initiating computing device (102) or the invited computing device (104) may be stored on the server (106) for use in calculations, creation of documents, charging fees, initiating further communications, or for other purposes.

FIG. 2 is a flow diagram of an exemplary process (200) for conducting a settlement process between a initiating party and an invited party, which may be performed on the server (106). In the example process (200), the initiating party input is received, where the input is a first dispute amount and a first offer amount (202). Similarly, the invited party input is received, where the input is a second dispute amount and a second offer amount (204). The first dispute amount is the monetary amount in controversy from the initiating party's perspective. Likewise, the second dispute amount is the monetary amount in controversy from the invited party's perspective. In other words, the first dispute amount represents the approximate amount the initiating party believes is owed, either to or from the initiating party; and the second dispute amount represents the approximate amount the invited party believes is owed, either to or from the invited party.

Next, the first dispute amount is compared to the second dispute amount to determine a dispute amount difference (206). The dispute amount difference may be calculated, for example, by taking the absolute value of difference of the first dispute amount and the second dispute amount, which may be represented numerically or as a percentage difference. In a preferred embodiment, the dispute amount difference is represented as a percentage difference, which is then compared to a maximum allowable dispute amount difference to determine if the dispute amount difference exceeds the maximum (208).

When the dispute amount difference exceeds the maximum, an updated dispute amount prompt is communicated to and caused to display on one or both of the initiating (102) and the invited (104) computing devices (210). The purpose of this step is to gauge the probability of a successful settlement. If the dispute amounts entered by each party are wildly different, there is little probability that the parties will agree to a suggested settlement, and prevents wasted time and frustration for both parties. The maximum dispute amount may vary according to correlations found in prior settlement amounts. For example, it may be found that if a dispute amount difference exceeds 10%, the chance of successful settlement drastically decreases. Thus, the maximum dispute amount difference may be set at 10%. In another example, the maximum dispute amount difference may require that the first and second dispute amounts be within an order of magnitude of one another. Yet other example maximum dispute amount differences may be 20%, 30%, 40%, 50%, 60%, 70%, 80%, and 90% difference. The first dispute amount, the second dispute amount, and the dispute amount difference may be displayed on either or both of the initiating (102) and the invited (104) computing devices, so that both parties know the differences in the dispute amounts. Alternately, if the dispute amount difference exceeds the maximum dispute amount difference, the parties may simply be informed that they are too far apart and should adjust their respective positions, without displaying the dispute amount difference.

If the dispute amount difference does not exceed the maximum dispute amount difference, then the present method determines a suggested settlement amount, at least in part calculated from a dataset containing the first offer amount and the second offer amount (212). The first offer amount entered at step (202), represents an initial best offer from the initiating party, or an initial monetary amount that would cause the initiating party to settle, if accepted by the invited party. Similarly, the second offer amount entered at step (204), represents an initial best offer from the invited party, or an initial monetary amount that would cause the invited party to settle, if accepted by the initiating party. As will be further described below, each party may enter updated offer amounts, as prompted by the system. Generally, the first and second offer amounts are kept in confidence, so that the first offer amount is not communicated to the invited computing device, and the second offer amount is not communicated to the initiating computing device.

Once a suggested settlement amount has been determined (212), both parties are notified to securely log on to the server where the suggested settlement amount is communicated to and is caused to display on the initiating computing device (102) and the invited computing device (104).

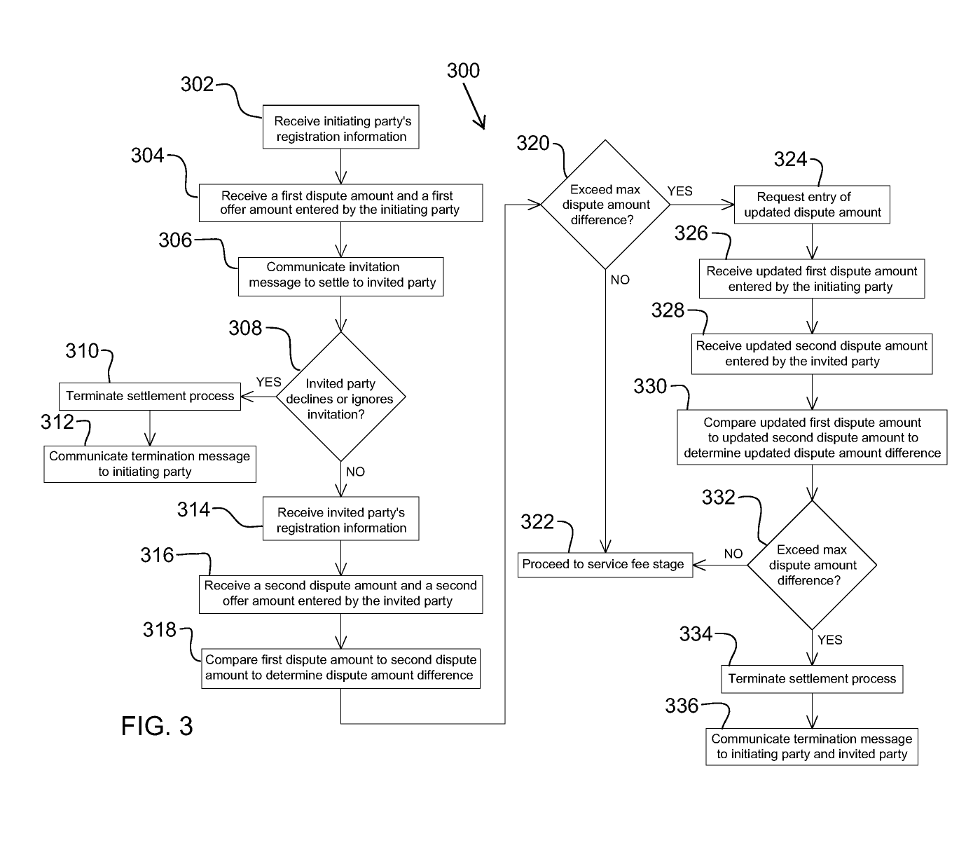

Another embodiment of the present system and method is illustrated in FIG. 3, which a flow diagram of an exemplary process (300) for an initiating party to invite an invited party to participate in the settlement process, including at least some steps as disclosed in FIG. 2. The initiating party enters his, hers, or its (in the case of a corporation, etc.) registration information (302), which may include the name, account name, contact information, the first case description summary, evidence (such as receipts, contracts, photos or other pertinent document), and the invited party's contact information (such as an email address), which is received by the server (106). Then, the first dispute amount and the first offer amount is received (304). The initiating party enters a first case description summary; and invited party may accept the summary or enter a second case description summary.

An invitation message is communicated to the invited party (304). In one example, an email message is sent containing the invitation to participate in the settlement process and a link to the settlement website. The settlement website is preferably a confidential portal through which the settlement information is communicated to the one or both of the initiating (102) and invited (104) computing devices. For example, the initiating computing device (102) may display a confidential initiating party portal through an initiating graphical user interface, and the invited computing device (104) may display a confidential invited party portal an invited graphical user interface, through which confidential and shared information may be sent or received.

If the invited party ignores the invitation message or actively declines the invitation (308), then the settlement process is terminated (310), and a termination message is sent to the initiating party (312), by email, through the confidential initiating party portal, by cellular phone text message, or other communication means.

If the invited party accepts the invitation, then the invited party enters his, hers, or its registration information (314), which may include the name, account name, contact information, the second case description summary, and evidence (such as receipts, contracts, or other pertinent document), which is received by the server (106). Then, the second dispute amount and the second offer amount is received (316).

The first dispute amount is compared to the second dispute amount to determine a dispute amount difference (318), as described in reference to FIG. 2, step (206). The dispute amount difference is compared to a maximum allowable dispute amount difference to determine if the dispute amount difference exceeds the maximum (320). If the dispute amount difference exceeds the maximum, an updated dispute amount prompt is communicated to and caused to display on one or both of the initiating (102) and the invited (104) computing devices (324).

The updated first dispute amount is received (326), if entered by the initiating party on the initiating computing device (102). And, the updated second dispute amount is received (328), if entered by the invited party on the invited computing device (104). The updated first dispute amount is compared to the updated second dispute amount to determine an updated dispute amount difference (330)

The updated dispute amount difference is compared to the maximum allowable dispute amount difference to determine if the updated dispute amount difference exceeds the maximum (332). If the dispute amount difference exceeds the maximum, the settlement process is terminated (334), and a termination message is sent to the initiating (102) and invited (104) computing devices (336). As an option, a renewed updated dispute amount prompt may be communicated to and caused to display on one or both of the initiating (102) and the invited (104) computing devices, permitting the entry of yet another dispute amount by one or both parties. Thus, in this optional example, each party is permitted three entries of dispute amounts before termination of the process.

When the dispute amount difference does not exceed the maximum dispute amount difference (320) or when the updated dispute amount difference does not exceed the maximum dispute amount difference (332), the process is advanced to the service fee stage (322).

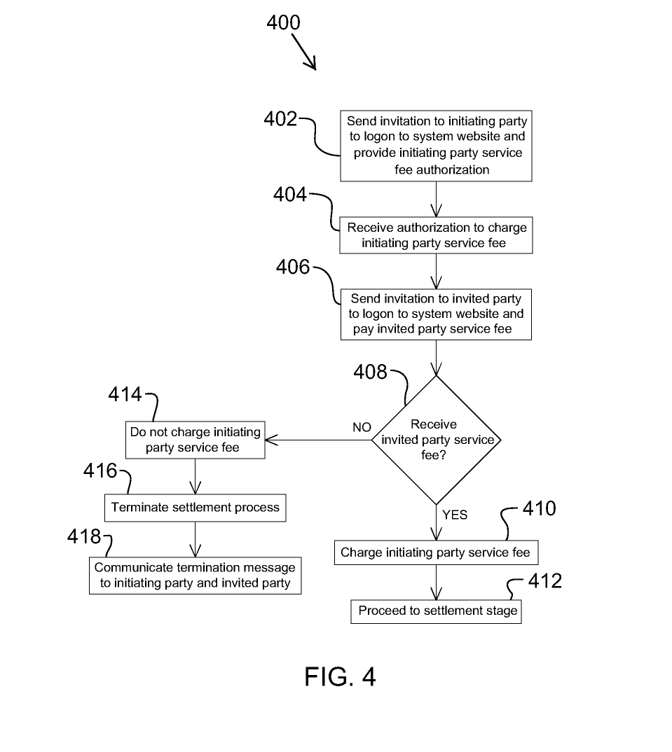

FIG. 4 discloses a flow diagram of an exemplary process (400) for charging a service fee to both parties. Prepayment of a service fee may cause the initiating party to hesitate, as the initiating party may be unsure of the invited party's good faith and willingness to engage in the settlement process. Thus, the present process (400) allows for the authorization to charge a service fee to the initiating party, without charging the fee until the service fee is collected from the invited party. After the initiating party has registered (302), the system sends a communication or invitation requesting the initiating party provide authorization to be charged a initiating party service fee (such as providing a credit card or bank account routing number) (402). The initiating party may be required to log on to the service by entering a user name and password. When the authorization to charge the service fee to the initiating party is received (406), an invitation is sent to the invited party to create an account or log on to a created account, so that a invited party service fee may be charged (406).

If the invited party service fee is received (408), then the initiating party service fee is actually charged (410) and the process is advanced to the settlement process stage (412). In this way, the initiating party is not charged until the invited party agrees to pay or actually pays the invited party service fee. Both parties paying the service fee generally indicates that the settlement process will likely be taken seriously and in good faith.

If, however, the invited party service fee is not received or not charged (414), then the settlement process is terminated (416), and a termination message is sent to the initiating party and invited party (418), by email, through the confidential initiating party portal, by cellular phone text message, or other communication means.

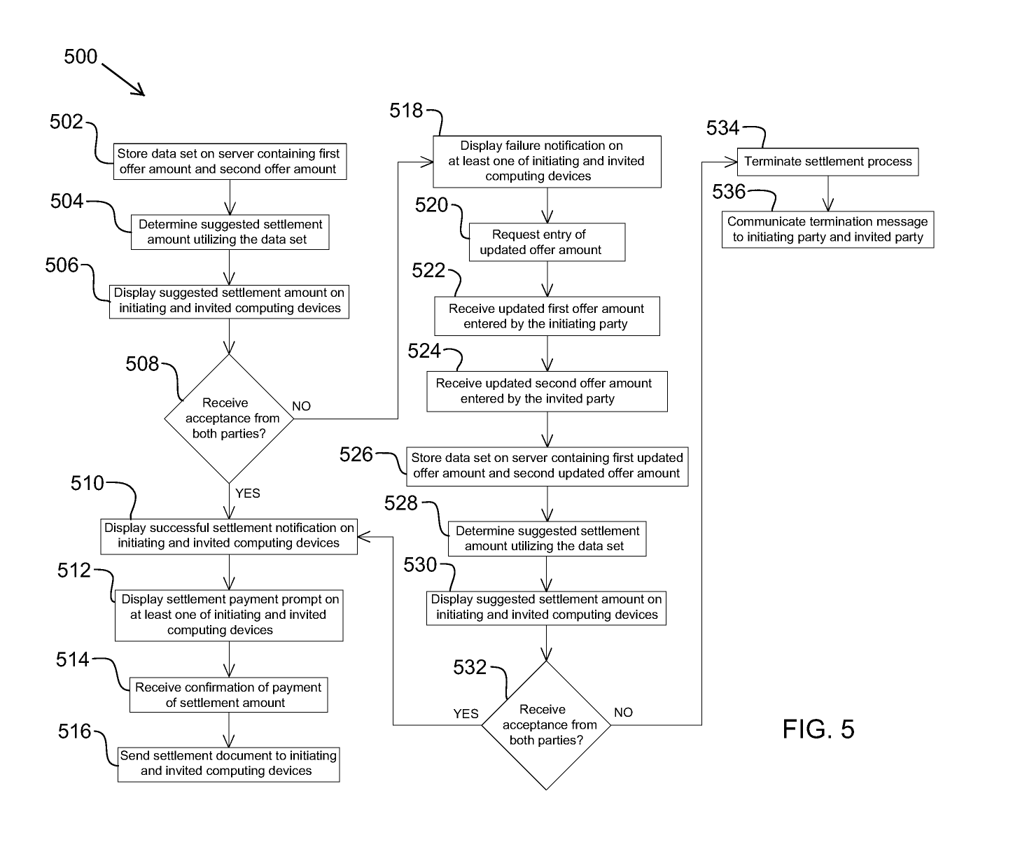

FIG. 5 depicts a flow diagram of an exemplary process (500) for determining settlement amount to facilitate a settlement between the parties. After both parties enter respective dispute amounts and offer amounts and the system has determined that the dispute amount difference or updated dispute amount difference does not exceed the maximum dispute amount difference (as described in FIG. 3), a data set containing the first offer amount and the second offer amount is stored on the server (106) memory (502). The data set may optionally further contain at least one of the first dispute amount, the second dispute amount, the updated first dispute amount, and the updated second dispute amount. A suggested settlement amount is calculated or otherwise determined utilizing the quantities in the dataset (504). The suggested settlement amount may be a quantity between the first offer amount and the second offer amount. The suggested settlement amount is communicated to and caused to display on the initiating computing device (102) and the invited computing device (104) (506), preferably through a confidential secured portal. Due to the confidential nature of the settlement process, an notification may be sent to the email addresses associated with each party. The email notifies the party of an occurrence, and prompts the party to logon to the party's account to view the message. For example, when the suggested settlement amount is determined, an email notification of this event is sent to the initiating party and the invited party. In order to view the settlement amount, the parties must logon to the website or application portal.

The parties are given the option to accept or decline the suggested settlement amount (508). If a decline message is received from one or both parties, then a failure notification is caused to display on one or both of the initiating computing device (102) and the invited computing device (104) (518). The initiating party may be given an opportunity to enter an updated first offer amount. And, invited party may be given an opportunity to enter an updated second offer amount. The updated offer amounts from each party may be the same or different from the offer amount originally entered. The updated first offer amount is received (522). And, the updated second offer amount is received (524). The process may be optionally terminated if either one or both of the updated offer amounts are not received.

A data set at least containing the updated first offer amount and the updated second offer amount is stored on the server (106) memory (526). The data set may optionally further contain at least one of the first offer amount, the second offer amount, the first dispute amount, the second dispute amount, the updated first dispute amount, and the updated second dispute amount. An updated suggested settlement amount is calculated or otherwise determined utilizing the quantities in the dataset (528). The updated suggested settlement is communicated to each party and the updated amount is caused to display on the initiating computing device (102) and the invited computing device (104) (530), preferably through a confidential secured portal.

The parties are once again given the option to accept or decline the suggested settlement amount (532). If a decline message is received from one or both parties, then a failure notification is caused to display on one or both of the initiating computing device (102) and the invited computing device (104) (518), and the settlement process may be terminated (536). As an option, the parties may be given yet another opportunity to enter a renewed updated offer amount, permitting a third round of attempted settlement.

If an indication of acceptance is received from both the initiating computing device (102) and the invited computing device (104), then a successful settlement notification is caused to display on the initiating computing device (102) and the invited computing device (104) (510).

Depending on whether the initiating party or invited party is the debtor, a settlement payment prompt is caused to display on one of the initiating computing device (102) and the invited computing device (104) (512). The debt owed by the debtor would be equivalent to the suggested settlement amount or the updated suggested settlement amount. For example, if the invited party is the debtor, the settlement payment prompt is caused to display on the invited computing device (104). In this case, the invited party would enter payment information, such as a credit card number or bank account routing number, for payment of the agreed debt. The present system or a third party system may process or facilitate the payment of the debt to the creditor, the initiating party in this example. Payment may involve transfer of funds from the debtor's payment source to the creditor's bank account or other indicated account.

After payment of the suggested settlement amount by the debtor, confirmation of the payment is received. A payment confirmation message may be sent to the creditor's computing device (102 or 104). Further, a settlement document may be communicated to the initiating computing device (102) and the invited computing device (104), describing the settlement terms and other pertinent information.

Aspects of the present specification may also be described as follows:

1. A method of facilitating a monetary settlement process in connection with a dispute between an initiating party utilizing an initiating computing device and an invited party utilizing an invited computing device, the method comprising the steps of: under control of one or more computing systems configured with executable instructions; receiving a first dispute amount and a first offer amount entered by the initiating party on the initiating computing device; receiving a second dispute amount and a second offer amount entered by the invited party on the invited computing device; comparing the first dispute amount to the second dispute amount to determine a dispute amount difference; determining a suggested settlement amount utilizing a data set, the data set containing at least one of the first offer amount and the second offer amount; and causing the suggested settlement amount to be displayed on the initiating computing device and the invited computing device.

2. The method according to embodiment 1, further comprising the steps of: comparing the dispute amount difference with a maximum dispute amount difference; and when the dispute amount difference exceeds the maximum dispute amount difference, causing a dispute update prompt to be displayed on at least one of the initiating computing device and the invited computing device, the dispute update prompt requesting entry of an updated dispute amount.

3. The method according to embodiments 1-2, further comprising the steps of: when the dispute amount difference exceeds the maximum dispute amount difference: causing a first dispute update prompt to be displayed on the initiating computing device, the first dispute update prompt requesting entry of an updated first dispute amount; causing a second dispute update prompt to be displayed on the invited computing device, the second dispute update prompt requesting entry of an updated second dispute amount; receiving the updated first dispute amount entered by the initiating party on the initiating computing device; receiving an updated second dispute amount entered by the invited party on the invited computing; and comparing the updated first dispute amount to the updated second dispute amount to determine an updated dispute amount difference.

4. The method according to embodiments 1-3, further comprising the step of terminating the monetary settlement process if at least one of the updated first dispute amount and the updated second dispute amount are not received.

5. The method according to embodiments 1-4, further comprising the steps of: causing an invitation message to be displayed on the invited computing device, the invitation message communicating a request to the invited party to participate in the monetary settlement process; and causing an initial prompt to be displayed on the invited computing device, the initial prompt requesting entry of the second dispute amount and the second offer amount.

6. The method according to embodiments 1-5, further comprising the step of terminating the monetary settlement process if at least one of the second dispute amount and the second offer amount are not received.

7. The method according to embodiments 1-6, further comprising the steps of: receiving an initiating party authorization from the initiating computing device, the initiating authorization granting permission from the initiating party to authorize an initiating party service fee prior to the step of causing an invitation message to be displayed on the invited computing device; causing an invited party service fee to be displayed on the invited computing device; and when an invited party authorization is received, charging the initiating party service fee and charging the invited party service fee, the invited party authorization granting permission of the invited party to charge the invited party service fee.

8. The method according to embodiments 1-7, wherein the step of determining the suggested settlement amount comprises the step of determining a quantity that lies between the first offer amount and the second offer amount.

9. The method according to embodiments 1-8, further comprising the step of including in the data set at least one of the first dispute amount and the second dispute amount.

10. The method according to embodiments 1-9, further comprising the step of terminating the monetary settlement process if the invited authorization is not received.

11. The method according to embodiments 1-10, further comprising the step of preventing disclosure of the first offer amount to the invited computing device and preventing disclosure of the second offer amount to the initiating computing device.

12. The method according to embodiments 1-11, wherein the initiating computing device is capable of displaying an initiating graphical user interface and the invited computing device is capable of displaying an invited graphical user interface, and the step of causing the suggested settlement amount to be displayed further comprising: causing the suggested settlement amount and an initiating party settlement option to be displayed within the initiating graphical user interface, the initiating party settlement option permitting entry by the initiating party acceptance or rejection of the suggested settlement amount; and causing the suggested settlement amount and an invited party settlement option to be displayed within the invited graphical user interface, the invited party settlement option permitting entry by the invited party acceptance or rejection of the suggested settlement amount.

13. The method according to embodiments 1-12, further comprising the steps of: receiving an initiating party settlement decision; receiving an inviting party settlement decision; and causing a settlement outcome to be displayed on at least one of the initiating computing device and the invited computing device.

14. The method according to embodiments 1-13, further comprising the step of, when at least one of an initiating party settlement decision and the invited party settlement decision indicates rejection of the suggested settlement amount, causing a failure notification to be displayed on at least one of the initiating computing device and the invited computing device.

15. The method according to embodiments 1-14, further comprising the step of causing an offer update prompt to be displayed on at least one of the initiating computing device and the invited computing device, the offer update prompt requesting entry of an updated offer amount.

16. The method according to embodiments 1-15, further comprising the steps of: communicating a first offer update prompt to the initiating computing device requesting entry of an updated first offer amount; and communicating a second offer update prompt to the invited computing device requesting entry of an updated second offer amount.

17. The method according to embodiments 1-16, further comprising the steps of: receiving the updated first offer amount, entered on the initiating computing device; receiving the updated second offer amount, entered on the invited computing device; determining an updated suggested settlement amount utilizing an updated data set containing at least one of the updated first offer amount and the updated second offer amount; and causing the updated suggested settlement amount to be displayed on the initiating computing device and the invited computing device.

18. The method according to embodiments 1-17, further comprising the step of including in the updated data set the first offer amount, the second offer amount, the updated first offer amount, and the updated second offer amount.

19. The method according to embodiments 1-18, further comprising the steps of: receiving a first case description summary entered on the initiating computing device; and receiving a second case summary entered on the inviting computing device.

20. The method according to embodiments 1-19, further comprising the step of, when the initiating party decision and the invited party decision both indicate an acceptance of the suggested settlement amount, causing a successful settlement notification to be displayed on the initiating computing device and the invited computing device.

21. The method according to embodiments 1-20, further comprising the steps of: causing a settlement payment prompt to be displayed on one of the initiating computing device and the invited computing device, the settlement payment prompt requesting the payment of a debt amount indicated in the suggested settlement amount; and receiving a debt payment confirmation.

22. The method according to embodiments 1-21, further comprising the step of communicating a settlement document to the initiating computing device and the invited computing device, the settlement document describing settlement terms of the dispute.

23. A method for facilitating a monetary settlement process in connection with a dispute between an initiating party and an invited party, the method comprising the steps of: implementing a central computer system in communication with each of an initiating computing device under the control of the initiating party and an invited computing device under the control of the invited party; and upon the initiating party and invited party desiring to negotiate a monetary settlement of the dispute through the central computer system: receiving from the initiating computing device a first dispute amount and a first offer amount; receiving from the invited computing device a second dispute amount and a second offer amount; comparing the first dispute amount to the second dispute amount to determine a dispute amount difference; determining a suggested settlement amount utilizing a data set, the data set containing at least one of the first offer amount and the second offer amount; and transmitting the suggested settlement amount to each of the initiating computing device and the invited computing device.

24. A system for facilitating a monetary settlement process in connection with a dispute between an initiating party and an invited party, the system comprising: an initiating computing device under the control of the initiating party; an invited computing device under the control of the invited party; and a central computer system in communication with each of the initiating computing device and invited computing device; wherein, upon the initiating party and invited party desiring to negotiate a monetary settlement of the dispute through the computer system, the computer system is configured for: receiving from the initiating computing device a first dispute amount and a first offer amount; receiving from the invited computing device a second dispute amount and a second offer amount; comparing the first dispute amount to the second dispute amount to determine a dispute amount difference; determining a suggested settlement amount utilizing a data set, the data set containing at least one of the first offer amount and the second offer amount; and transmitting the suggested settlement amount to each of the initiating computing device and the invited computing device.

In closing, regarding the exemplary embodiments of the present invention as shown and described herein, it will be appreciated that a system and method for facilitating settlement between disputing parties is disclosed. Because the principles of the invention may be practiced in a number of configurations beyond those shown and described, it is to be understood that the invention is not in any way limited by the exemplary embodiments, but is generally directed to a system and method for facilitating settlement between disputing parties and is able to take numerous forms to do so without departing from the spirit and scope of the invention. Furthermore, the various features of each of the above-described embodiments may be combined in any logical manner and are intended to be included within the scope of the present invention.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the present invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present invention so claimed are inherently or expressly described and enabled herein.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment.

The methods as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A method of facilitating a monetary settlement process in connection with a dispute between an initiating party utilizing an initiating computing device and an invited party utilizing an invited computing device, the method comprising the steps of:
under control of one or more computing systems configured with executable instructions;
receiving a first dispute amount and a first offer amount entered by the initiating party on the initiating computing device;
receiving a second dispute amount and a second offer amount entered by the invited party on the invited computing device;
comparing the first dispute amount to the second dispute amount to determine a dispute amount difference;
determining a suggested settlement amount utilizing a data set, the data set containing at least one of the first offer amount and the second offer amount; and
causing the suggested settlement amount to be displayed on the initiating computing device and the invited computing device.

2. The method of claim 1, further comprising the steps of:
comparing the dispute amount difference with a maximum dispute amount difference; and
when the dispute amount difference exceeds the maximum dispute amount difference, causing a dispute update prompt to be displayed on at least one of the initiating computing device and the invited computing device, the dispute update prompt requesting entry of an updated dispute amount.

3. The method of claim 2, further comprising the steps of, when the dispute amount difference exceeds the maximum dispute amount difference:
causing a first dispute update prompt to be displayed on the initiating computing device, the first dispute update prompt requesting entry of an updated first dispute amount;
causing a second dispute update prompt to be displayed on the invited computing device, the second dispute update prompt requesting entry of an updated second dispute amount;
receiving the updated first dispute amount entered by the initiating party on the initiating computing device;
receiving an updated second dispute amount entered by the invited party on the invited computing; and
comparing the updated first dispute amount to the updated second dispute amount to determine an updated dispute amount difference.

4. The method of claim 3, further comprising the step of terminating the monetary settlement process if at least one of the updated first dispute amount and the updated second dispute amount are not received.

5. The method of claim 1, further comprising the steps of:
causing an invitation message to be displayed on the invited computing device, the invitation message communicating a request to the invited party to participate in the monetary settlement process; and
causing an initial prompt to be displayed on the invited computing device, the initial prompt requesting entry of the second dispute amount and the second offer amount.

6. The method of claim 5, further comprising the step of terminating the monetary settlement process if at least one of the second dispute amount and the second offer amount are not received.

7. The method of claim 5, further comprising the steps of:
receiving an initiating party authorization from the initiating computing device, the initiating authorization granting permission from the initiating party to authorize an initiating party service fee prior to the step of causing an invitation message to be displayed on the invited computing device;
causing an invited party service fee to be displayed on the invited computing device; and
when an invited party authorization is received, charging the initiating party service fee and charging the invited party service fee, the invited party authorization granting permission of the invited party to charge the invited party service fee.

8. The method of claim 1, wherein the step of determining the suggested settlement amount comprises the step of determining a quantity that lies between the first offer amount and the second offer amount.

9. The method of claim 1, further comprising the step of including in the data set at least one of the first dispute amount and the second dispute amount.

10. The method of claim 1, wherein the initiating computing device is capable of displaying an initiating graphical user interface and the invited computing device is capable of displaying an invited graphical user interface, and the step of causing the suggested settlement amount to be displayed further comprising:
causing the suggested settlement amount and an initiating party settlement option to be displayed within the initiating graphical user interface, the initiating party settlement option permitting entry by the initiating party acceptance or rejection of the suggested settlement amount; and
causing the suggested settlement amount and an invited party settlement option to be displayed within the invited graphical user interface, the invited party settlement option permitting entry by the invited party acceptance or rejection of the suggested settlement amount.

11. The method of claim 10, further comprising the steps of:
receiving an initiating party settlement decision;
receiving an inviting party settlement decision; and
causing a settlement outcome to be displayed on at least one of the initiating computing device and the invited computing device.

12. The method of claim 10, further comprising the step of, when at least one of an initiating party settlement decision and the invited party settlement decision indicates rejection of the suggested settlement amount, causing a failure notification to be displayed on at least one of the initiating computing device and the invited computing device.

13. The method of claim 12, further comprising the step of causing an offer update prompt to be displayed on at least one of the initiating computing device and the invited computing device, the offer update prompt requesting entry of an updated offer amount.

14. The method of claim 13, further comprising the steps of:
communicating a first offer update prompt to the initiating computing device requesting entry of an updated first offer amount; and
communicating a second offer update prompt to the invited computing device requesting entry of an updated second offer amount.

15. The method of claim 14, further comprising the steps of:
receiving the updated first offer amount, entered on the initiating computing device;
receiving the updated second offer amount, entered on the invited computing device;
determining an updated suggested settlement amount utilizing an updated data set containing at least one of the updated first offer amount and the updated second offer amount; and
causing the updated suggested settlement amount to be displayed on the initiating computing device and the invited computing device.

16. The method of claim 15, further comprising the step of including in the updated data set the first offer amount, the second offer amount, the updated first offer amount, and the updated second offer amount.

17. The method of claim 1, further comprising the steps of:
receiving a first case description summary entered on the initiating computing device; and
receiving a second case summary entered on the inviting computing device.

18. The method of claim 17, further comprising the steps of, when the initiating party decision and the invited party decision both indicate an acceptance of the suggested settlement amount:
causing a successful settlement notification to be displayed on the initiating computing device and the invited computing device.
causing a settlement payment prompt to be displayed on one of the initiating computing device and the invited computing device, the settlement payment prompt requesting the payment of a debt amount indicated in the suggested settlement amount;
receiving a debt payment confirmation; and
communicating a settlement document to the initiating computing device and the invited computing device, the settlement document describing settlement terms of the dispute.

19. A method for facilitating a monetary settlement process in connection with a dispute between an initiating party and an invited party, the method comprising the steps of:
implementing a central computer system in communication with each of an initiating computing device under the control of the initiating party and an invited computing device under the control of the invited party; and
upon the initiating party and invited party desiring to negotiate a monetary settlement of the dispute through the central computer system:
receiving from the initiating computing device a first dispute amount and a first offer amount;
receiving from the invited computing device a second dispute amount and a second offer amount;
comparing the first dispute amount to the second dispute amount to determine a dispute amount difference;
determining a suggested settlement amount utilizing a data set, the data set containing at least one of the first offer amount and the second offer amount; and
transmitting the suggested settlement amount to each of the initiating computing device and the invited computing device.

20. A system for facilitating a monetary settlement process in connection with a dispute between an initiating party and an invited party, the system comprising:
an initiating computing device under the control of the initiating party;
an invited computing device under the control of the invited party; and
a central computer system in communication with each of the initiating computing device and invited computing device;
wherein, upon the initiating party and invited party desiring to negotiate a monetary settlement of the dispute through the computer system, the computer system is configured for:
receiving from the initiating computing device a first dispute amount and a first offer amount;
receiving from the invited computing device a second dispute amount and a second offer amount;
comparing the first dispute amount to the second dispute amount to determine a dispute amount difference;
determining a suggested settlement amount utilizing a data set, the data set containing at least one of the first offer amount and the second offer amount; and
transmitting the suggested settlement amount to each of the initiating computing device and the invited computing device.
